(19) United States
(12) Patent Application Publication
(10) Pub. No.: US 2004/0078206 A1
(43) Pub. Date: Apr. 22, 2004

(54) System and method for generating orchestra programs

(76) Inventors: Allison Beth Vulgamore, Atlanta, GA (US); Charles Raymond Wade, Marietta, GA (US); Mary Styron Wilson, Atlanta, GA (US)

Correspondence Address: STEPHEN D. SCANLON, JONES DAY, 901 LAKESIDE AVENUE, CLEVELAND, OH, 44114, US

(21) Appl. No.: 10/073,684

(22) Filed: Feb. 11, 2002

(51) Int. Cl. G06F 17/60

(52) U.S. Cl. 705/1

(57) ABSTRACT

A collaborative musical program generation process and system that involves the orchestra's music director, an executive administrative member of the orchestra, and a guest conductor. The music director has responsibility for musical programming throughout substantially an entire musical season of the orchestra organization. The executive member performs an administration function within the orchestra organization. The guest conductor is invited by the orchestra organization to conduct a plurality of musical programs for the orchestra. The music director, executive administrative member, and guest conductor together formulate one or more musical programs for the orchestra organization.

### RELATED APPLICATION

This application claims priority to U.S. provisional application Serial No. (to be assigned) entitled “SYSTEM AND METHOD FOR GENERATING ORCHESTRA PROGRAMS” filed Feb. 1, 2002 (with Express Mail Number EL647388709US and law firm identification number 979569). By this reference, the full disclosure of this U.S. provisional application entitled “SYSTEM AND METHOD FOR GENERATING ORCHESTRA PROGRAMS” is incorporated herein.

### BACKGROUND AND SUMMARY

The present invention relates to the field of musical orchestra operations. In particular, this invention relates to a method and system for generating orchestra musical programs.

Historically, the organization of symphony orchestras has been hierarchical in structure. Decision-making has been generally dominated by the music director who makes the all-important artistic and programming decisions in relative isolation, without a formalized system of input from across the organization. The executive director and occasionally the board of directors are generally ineffective in providing counter balance for the organization. This misalignment has been in large part responsible for the uneven record of the orchestra industry. The public perception of orchestras as “being in trouble” or “out of touch” is supported by news stories of a handful of orchestras that are perennially at risk.

The present invention includes a system and method that represent a transformational strategy for orchestras. The present invention is a unique internal collaborative musical program generation process and system that involves the orchestra's music director, an executive administrative member of the orchestra (e.g., the orchestra's president), and a guest conductor (e.g., a principal guest conductor). The music director has responsibility for musical programming throughout substantially an entire musical season of the orchestra organization. The executive administrative member performs an administration function within the orchestra organization. The guest conductor is invited by the orchestra organization to conduct one or more musical programs for the orchestra. The music director, executive administrative member, and guest conductor together formulate musical programs for the orchestra organization.

### BRIEF DESCRIPTION OF THE DRAWINGS

The present invention satisfies the general needs noted above and provides many advantages, as will become apparent from the following description when read in conjunction with the accompanying drawings, wherein:

FIG. 1 is a block diagram depicting a collaborative musical program generation process and system;

FIG. 2 is a block diagram depicting a collaborative musical program generation process and system using additional personnel; and

FIG. 3 is a block diagram depicting a collaborative musical program generation process and system using forecasting model analysis.

### DETAILED DESCRIPTION OF THE PREFERRED EMBODIMENT

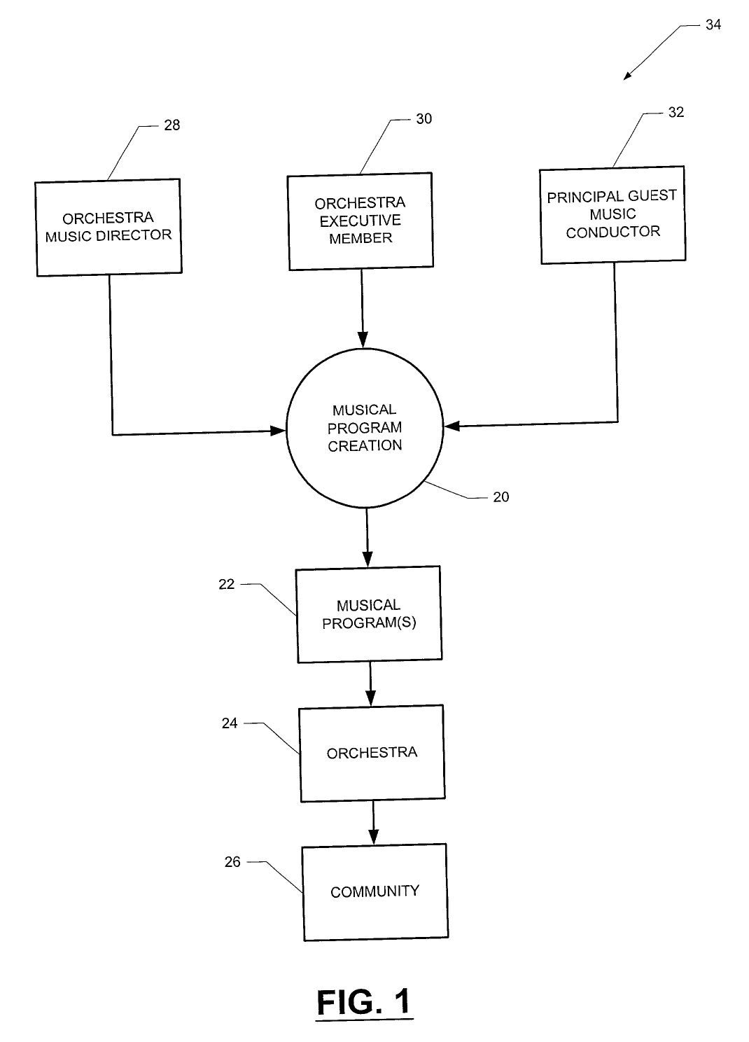

FIG. 1 depicts a new orchestra musical program generation process and system 20. This unique internal collaborative process and system 20 generates one or more musical programs 22 for an orchestra 24 to play to a community 26. One or substantially an entire season or entire season of musical programs 22 may be generated. The musical program generation process and system 20 involve the orchestra's music director 28, an executive member 30 of the orchestra 24 (e.g., the orchestra's president), and a guest conductor 32 (e.g., a principal guest conductor). The music director 28 helps lead discussions and dialogue with the various constituencies that make up the orchestra musicians, board, staff, chorus, youth orchestra, audience and community. The music director 28 may also conduct one or more or the musical programs during the musical season.

The executive member 32, such as the orchestra's president, is charged with assessing the effect of activities within the orchestra organization upon budgetary limitations approved by the orchestra's board of directors and the effect upon the community 26. The president may also facilitate discussions among the various orchestra members and provide annual retreats and long range planning forums for the entire orchestra community. Typically, the president has a better understanding of which musical programs have broader appeal to the community. Moreover it should be understood that in different embodiments, different types of executive members may be used provided they can instill a degree of business practicality and community-relatedness to the musical program generation process. In another different embodiment, the executive member 30 may be from a different orchestra who is contracted to assist the musical program generation process and system 20 of the orchestra 24.

Typically, the music director 28 has a contract that states how many weeks the music conductor 28 will conduct the orchestra 24. For example, a music director 28 may be contracted to conduct a minimum of ten classical subscription weeks. However, a season may last as long as twenty-four weeks (note that the duration depends upon the specific orchestra). Therefore, guest conductors are engaged. In most cases guest conductors are contracted on a performance-by-performance basis. The tripartite approach 34 has changed that by arranging that a “principal” guest conductor 32 be on a contractual basis and to collaborate on not only her programs but other programs throughout the season. For example, a principal guest conductor 32 may be engaged for four weeks or less (whereas typically a guest conductor may be engaged for only one or two weeks during a musical season). The principal guest conductor 32 mirrors in the new system and process 20 the music director 20 in cross constituency dialogue. It should be understood that a principal guest conductor or a guest conduct may be suitable to operate within the tripartite structure 34.

Thus in the tripartite approach 34, there are two conductors (28 and 32) as well as a president 30 planning a season in a collaborative manner. In a different embodiment, the tripartite approach 34 may be used to plan one or more musical programs 22 in a collaborative manner. These three positions are bound preferably by contract to not only promote the organizational conversation, but also to share in making important decisions to be advanced to the board of directors. In the event that a critical decision cannot be reached among the music director 28, president 30, and principal guest conductor 32 the executive committee of the board of directors led by the board chair resolves any such disputes. In different embodiments, the tripartite group 34 selects guest conductors and artists, chamber music forums, performance scheduling and choice of venues, physical performance space and education programs.

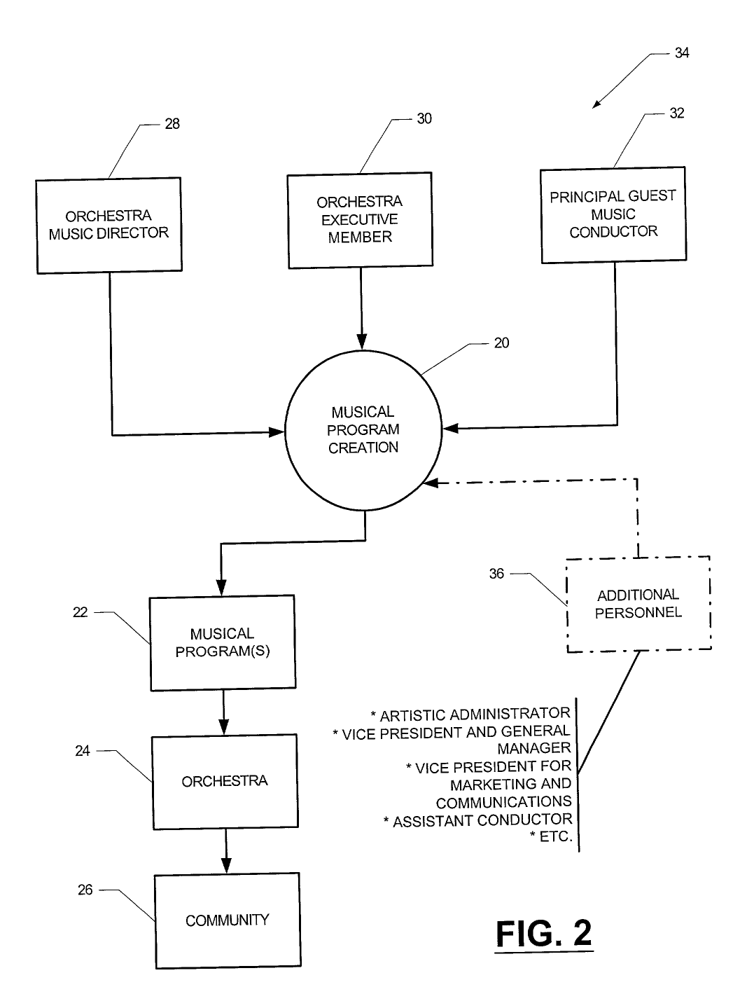

FIG. 2 illustrates a different embodiment wherein additional personnel 36 may be utilized in the musical program creation system and process 20. For example in addition to the music director 28, president 30, and principal guest conductor 32, the team may also include (but not necessarily) such additional personnel 36 as an artistic administrator, vice president and general manager, vice president for marketing and communications and the assistant conductor. Each member of the team brings a particular organizational perspective that is used before a product is placed on the market. The general manager focuses on cost and production; the president—overview of community/organization/funders; the artistic administrator—knowledge of programming and recent history/guest artist contacts; the two conductors—concern for the musical health and growth of the orchestra; the marketing VP—provide market data on the sales viability of suggested programs through the use of a predictive programming model.

This programming team balances the business needs, organizational and audience input with artistic vitality. This kind of structured discussion is not known to take place within any orchestra and the use of a broad team approach to what has been a strictly artistic process.

### Predictive Programming Model

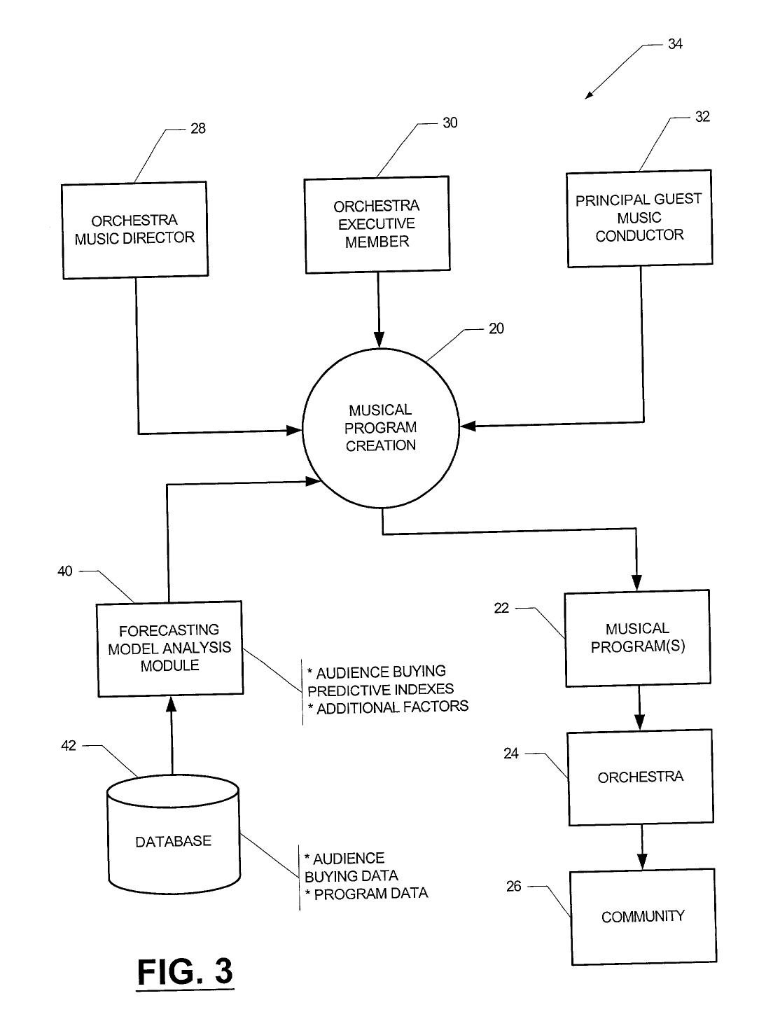

FIG. 3 illustrates the use within the musical program creation system and process 20 of a predictive programming model 40 designed to forecast ticket revenue and sales. The program is built using an off-the-shelf relational database 42 that examines one or more factors of audience buying patterns, such as time of year that tickets are purchased for and the sales numbers by composer. Using these two indexes and a variety of smaller adjustments (such as, adding value for the opening concert of the season, reducing value for certain religious holidays such as Passover, reducing value for concerts featuring singers, adding value for the last concert of the season). The orchestra marketing team may predict with a reasonable degree of accuracy sales volumes based on programming using off-the-shelf forecasting models. Forecasting models are not a part of the standard business practices of orchestras or performing arts groups in general.

The use of a predictive model is usually not possible or practical in an organization based on the traditional organizational form that places the important programming decision-making in the hands of the music director only. However, in the new system and process 20 the use of a business tool such as forecasting may be used to gather information and understanding/connection to the audience and community. Moreover, the unique organizational structure and the predictive model capability are used for both specific concert programs and for the totality of a season schedule.

### Example

As an example, consider that for the eighth concert in the season, the concert program was initially scheduled by the programming team (which included the music director, a guest director, and a management member, such as the executive director) to have as its keywork a Concerto by Hartmann and a Shostakovich Symphony to go along with an orchestra commissioned world premier by the composer Jennifier Higdon. The administrative president instilled a degree of practicality into the programming and used the predictive model to base her conclusion that such a program would have limited appeal (note: the initial program would be appealing for a very limited audience of highly involved classical music lovers and very little for the average listener). The programming team ran the numbers through the forecast model and evaluated the concert in relation to the entire season, the programming team adjusted the program by adding two very highly ranked composers and keeping the world premier and thereby significantly increasing the sales forecast. Other musical programs are created in a similar fashion. In such a manner, the new system systematically connects the organization together and promotes greater connection with and adaptation to the communities in which they live.

The embodiments described with reference to the drawing figures are presented only to demonstrate examples of the present invention. Additional, and/or alternative embodiments of the invention should be apparent to one of ordinary skill in the art upon reading this disclosure as the present invention is applicable in many ways. For example, the novel system and method are applicable to non-classical musical programs (e.g., orchestra musical pop programs).

It is claimed:

1. A system for generating musical programs for an orchestra organization, comprising:
a music director who in the orchestra organization has responsibility for musical programming throughout substantially an entire musical season of the orchestra organization;
an executive administrative member who performs an administration function within the orchestra organization; and
a guest conductor who is invited by the orchestra organization to conduct at least one musical program for the orchestra,
said music director and said executive administrative member and said guest conductor together formulating at least one musical program for the orchestra.

2. The system of claim 1 wherein the musical programs include classical musical programs.

3. The system of claim 1 wherein the musical programs include non-classical musical programs.

4. The system of claim 1 wherein the music director conducts for less than number of weeks in the musical season of the orchestra.

5. The system of claim 1 wherein the executive administrative member is president of the orchestra organization.

6. The system of claim 5 wherein the executive administrative member is responsible for assessing effect of activities within the orchestra organization upon budgetary limitations of the orchestra.

7. The system of claim 6 wherein the executive administrative member is responsible for assessing the effect of activities within the orchestra organization upon the community.

8. The system of claim 1 wherein the guest conductor is a principal guest conductor who conducts at least three programs for the orchestra during a season.

9. The system of claim 8 wherein the principal guest conductor mirrors the music director in cross constituency dialogue in formulating musical programs, said principal guest conductor and the music director and the executive administrative member together formulating musical programs for substantially an entire musical season of the orchestra organization.

10. The system of claim 9 further comprising:
a first contract that obligates the principal guest conductor to work with the executive administrative member and the music conductor to formulate musical programs for substantially an entire musical season of the orchestra organization.

11. The system of claim 10 further comprising:
a second contract that obligates the music conductor to work with the executive administrative member and the principal guest conductor to formulate musical programs for substantially an entire musical season of the orchestra organization.

12. The system of claim 1 wherein the music director and the executive administrative member and the guest conductor together select guest conductors and artists, chamber music forums, performance scheduling and choice of venues, physical performance space and education programs.

13. The system of claim 1 wherein the music director, the executive administrative member and the guest conductor together form a tripartite group, said system further comprising:
additional personnel means that are used by at least one member of the tripartite group to assist in formulating the musical programs for substantially an entire musical season of the orchestra organization.

14. The system of claim 1 wherein the music director, the executive administrative member and the guest conductor together form a tripartite group, wherein the tripartite group balances the business needs, organizational and audience input with artistic vitality in formulating the musical programs for substantially an entire musical season of the orchestra organization.

15. The system of claim 1 wherein the music director, the executive administrative member and the guest conductor together form a tripartite group, said system further comprising:
a database that stores historical musical programming-related data; and
a forecasting model analysis module connected to the database to generate at least one audience buying indicative statistic based upon the stored historical musical programming-related data and upon a candidate musical program, said tripartite group using the generated audience buying indicative statistic to assist in formulating at least one of the musical programs.

16. The system of claim 15 wherein said tripartite group uses the generated audience buying indicative statistic to assist in formulating substantially all of the musical programs for a musical season of the orchestra.

17. The system of claim 16 wherein the forecasting model analysis module predicts sales volumes based on a candidate musical program generated by the tripartite group.

18. A method for generating musical programs for an orchestra organization, comprising the steps of:
forming a first contract that obligates the music conductor to work with both an executive administrative member and a principal guest conductor to formulate musical programs for substantially an entire musical season of the orchestra organization;
forming a second contract that obligates the principal guest conductor to work with both the orchestra's executive administrative member and the orchestra's music conductor to formulate musical programs for substantially an entire musical season of the orchestra organization;
forming through the first and second contracts a tripartite group that includes the orchestra's music conductor, the orchestra's executive administrative member, and the orchestra's principal guest conductor; and
formulating with the tripartite group musical programs for substantially an entire musical season of the orchestra organization in a pre-selected musical genre.

19. The method of claim 18 wherein said music director has responsibility for musical programming throughout substantially an entire musical season of the orchestra organization, said executive administrative member performing an administration function within the orchestra organization, said principal guest conductor being invited by the orchestra organization to conduct a plurality of musical programs for the orchestra, said musical genre being classical music.

20. The method of claim 18 further comprising the steps of:
formulating candidate musical programs for substantially the entire musical season by the tripartite group; and
generating at least one audience buying indicative statistic based upon historical musical programming-related data and upon the candidate musical program, said tripartite group using the generated audience buying indicative statistic to assist in modifying at least one of the candidate musical programs.
